(19) United States
(12) Patent Application Publication
(10) Pub. No.: US 2007/0148048 A1
(43) Pub. Date: Jun. 28, 2007

(54) Microfluidic device

(76) Inventor: Fabien Frederic Raymond Marie Jousse, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/583,230

(22) PCT Filed: Nov. 9, 2004
(86) PCT No.: PCT/EP04/12747

§ 371 Date: Jun. 16, 2006

(30) Foreign Application Priority Data
Dec. 16, 2003 (EP) 030779095.0

(51) Int. Cl. B01L 3/00

(52) U.S. Cl. 422/100

(57) ABSTRACT

Microfluidic devices that comprise upstream channels that have a resistance higher than the resistance of the down stream channels are robust for blending two fluids, especially if they are oil and water or of different viscosities.

The invention relates to a microfluidic device, to the use of this device for preparing oil and water containing compositions and to a method for increase of throughput through such a device.

### BACKGROUND AND PRIOR ART

Microfluidic devices are widely used for biological assays and analytical processes. One of their well-known applications is in ELISA techniques and for use in DNA and RNA arrays. Also in combinatorial chemistry these devices are often used. Over time the microfluidic devices have been designed to perform all kind of tasks such as sensors, fluid distribution, arrays, mini factories and many others.

It is our aim to apply such devices in the production of end products, especially food products and personal care products. The use of microfluidic devices for the preparation of such products may provide several opportunities such as controlled product properties and product variety on small scale.

To enable their use for such application there is a need to provide a device, which is simple, provides reproducible results and delivers at sufficient throughput. Improved throughput is known to be achieved by use of many parallel microfluidic devices. The use of many parallel devices is referred to as scaling-out, equaling-up, or numbering-up.

It is well known, that the flow rate (Q) of a Newtonian fluid in a tube or channel is linked to the pressure difference (Dp) between the two ends of the tube by the relation:
Dp=R*Q,
where R is the fluid resistance of the tube or channel. In micro-channels the small dimensions usually imply that the Reynolds number is low, and hence that the flow is laminar. Furthermore, micro-channels usually present transverse dimensions, which are much smaller than their longitudinal dimension, and hence the flow is fully developed. In these conditions, the dimension of the channel generally characterizes the fluid resistance. For example, in a channel with a circular cross-section, the resistance takes the following form:
R=(8*m*L)/(π*d⁴)
where L is the length of the channel and d its diameter. As the resistance depends on the 4^{th} power of the channel diameter, a slight change in diameter can lead to large changes in the channel resistance. For example, 10% difference between the resistance of two circular microchannels with a nominal diameter of 50 microns can be caused by a difference in average diameter of 1.2 micron only. Such small differences may be caused by the inherent uncertainties of many micro-manufacturing techniques. Such small differences may also be caused by the deposition of impurities inside the channel, either before or during their use.

A liquid fed from a single source will partition between two or more micro-channels connected to this source according to the respective resistance of each channel. Accordingly, the equal feeding of several micro-channels or micro-reactors from several sources is difficult, as small differences in channel diameter will lead to large differences in resistance and hence un-equal partitioning of the fluid.

Another potential effect of such small differences can be observed when feeding two fluids of different viscosity, each from a single source, to two or more micro-reactors in parallel. For large enough difference of resistance between the channels, and viscosity difference between the fluids, it is observed that the least viscous fluid will entirely stop flowing down at least one of the micro-reactors. We will term this effect “multiphase shunt”. Such an effect is extremely damaging to the functioning of micro-reactors. It arises because the fluidic resistance of a channel, downstream of the points where the two fluids meet, depends on the effective viscosity of the mixture of the two fluids and therefore of the composition of the fluid mixture inside the downstream channel. Consequently, a slight difference in channel dimensions can lead to a difference in effective resistance, that is amplified by any viscosity difference between the two fluids.

Accordingly, the interfacing of many micro-reactors in parallel to the macroscopical world in a consistent, robust, and reliable manner poses problems. This has been addressed in the art.

Yoshikuni Kikutani et al (Lab chip 2002, 2, 193-196) describe some of the problems related to numbering-up. Problems that arise are e.g. liquid distribution, clogging, fluctuation in flow rate.

U.S. Pat. No. 6,268,219 discloses a fluid distribution system with a main channel and a plurality of branches extending therefrom. The main channel and the branches are coupled through a plurality of apertures with an aperture diameter. The aperture diameter progressively increases along the length of the main channel, thus distributing the fluid evenly to the branches. A capillary break positioned downstream on each branch must be overcome, with a pressure higher than the fill pressure, in order for fluid to be distributed. The presence of the capillary break makes this invention practical for only a single use. Hence there is no concern over pressure fluctuations.

The distribution system disclosed in this document may be satisfactory for production of a simple product based on one source material. However the provision of a product based on multiple ingredients is not possible with this device.

Furthermore, the number of branches that can be fed evenly with a simple manufacturing process is limited which limits the amount of devices that can be used in parallel for geometrical reasons. Therefore this device is unsuitable for high throughput production of complicated products relying on a multitude of ingredients.

Furthermore EP-A-1129772 describes a chemical processing system with 16 or more microreactors, as well as a fluid delivery system. The fluid delivery system is arranged spatially, so that the pressure-driven fluid flowing from a common port follows identical flow paths to reach the individual port of each of the individual microreactor. This is achieved by arranging the channels along a 2-dimensional binary tree with n levels, where one channel is divided in two at each level, thus allowing feeding 2ⁿ microreactors. The resulting arrangement insures that substantially the same pressure drop is experienced by all fluid elements arriving to the microreactors, provided that the relative difference between the resistance of the micro-channels leading to the micro-reactors, as well as those between the micro-reactors, is negligible. However in this embodiment each microreactor is fed from only one fluid source and does not include a multitude of phases arriving at each reactor. Furthermore it does not address potential problems, such as multiphase shunts, that may be due to relatively small differences between the resistance of the micro-reactors.

U.S. Pat. No. 6,086,740 presents a multiplexed microfluidic device including a plurality of modular elements attached to a common frame. This frame includes one or more common input elements, which are connected to the modular microfluidic elements. This document does not disclose how a reproducible product may be obtained with high throughput.

U.S. Pat. No. 6,251,343 describes microfluidic devices that comprise a body structure with a first microfluidic channel, a plurality of ports connecting to the channel, and a cover layer with a plurality of apertures, whereby each aperture is aligned with a separate one of the plurality of ports. Fluids are fed in the apertures in the cover layer, through the ports, into the microfluidic channels. Also this system does not address how to feed several microfluidic elements from a single aperture.

WO-A-00/60352 describes fluidic devices comprising two layers: a first layer of material comprising fluidic passages that define a microfluidic structure, and a second layer comprising fluidic passages defining a larger-scale fluidic structure; the sheets being joined such that the fluid passages of the first sheet communicate with those of the second sheet to form a fluidic device. This simple coupling is especially useful for the rapid prototyping of microfluidic test systems.

WO-A-02/11887 discloses similarly methods and devices for high throughput fluid delivery. The microfluidic device comprises a body structure with a microchannel network and at least one port in fluid communication with the channel network; and a manifold comprising at least one channel network and one aperture, whereby at least one aperture or one or more manifold channels are in fluid communication with one or more of the ports. By using several manifold layers, this arrangement allows the distribution of several fluids into the wells of the high-throughput assay.

WO-A-96/15576 describes a liquid distribution system allowing to feed several fluids to a number of parallel single units from two reservoirs. Each reservoir is connected to a channel network situated either above or below the parallel units to be fed and are made thus independent. However this cannot be generalized to a third flow path, let alone even more feeding channels.

U.S. Pat. No. 6,418,968 discloses a method of controlling flow in a microfluidic device by using high impedance porous membrane valves. The disclosure does not relate to the arrangement of the present invention.

Accordingly it is an object of the invention to provide a microfluidic device suitable for preparing complicated products based on several ingredients which products may be prepared at high throughput.

Furthermore it is an object of the present invention to provide a fluid distribution system, allowing to feed several fluid phases to any number of parallel microfluidic units from a single or multiple source for each phase, with substantially the same pressure at the inlet port of each of the microfluidic units, and stability of the flow to small pressure fluctuations or small differences between the resistance of each of the microfluidic units.

It has surprisingly been found that the relative resistance of upstream and downstream channels influences the robustness of a microfluidic system.

Therefore the invention relates to a microfluidic system comprising at least two upstream channels (α, β), each for the supply of fluid, and at least 2 downstream channel (γ), and at least 2 microfluidic reactors, wherein for one reactor, the resistance of the upstream channel or channels is higher than the resistance of the down stream channel or channels.

In a further aspect this invention relates to use of said microfluidic system for the preparation of food products and/or personal care products.

In another aspect the invention relates to a method for increasing throughput in a microfluidic device.

### DETAILED DESCRIPTION OF THE INVENTION

For the purpose of the invention microfluidic is defined as those processing systems, where the channel diameters are below 1 mm, preferably less than 0.1 mm.

For the purpose of the invention viscous fluid is defined as a fluid having a viscosity of more than 0.1 mPa·s at the applicable condition of shear and temperature.

The microfluidic system of the current invention provides one or more of the following advantages:
For each microfluidic reactor the pressure and flow conditions may be regulated without moving parts, and to be substantially the same for each microfluidic reactor
The system according to the invention helps minimise high feed length of feeding channels and hence is also suitable in case viscous fluids are used
The microfluidic system provides a compact, easily generated device
Stability of flow to small pressure fluctuations
A robust micro system showing reduced occurrence of multiphase shunts

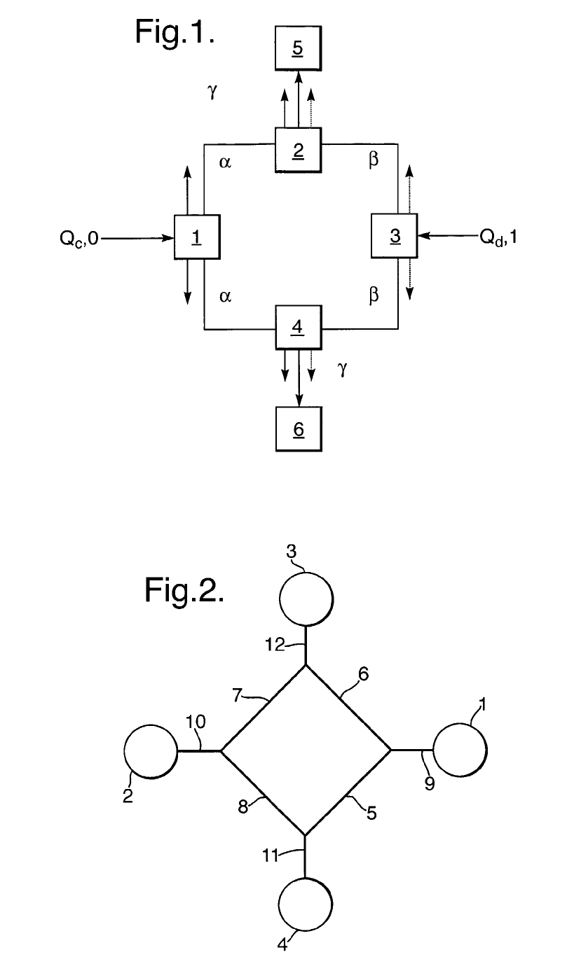

FIG. 1 shows one embodiment of a microfluidic system according to the invention. This embodiment is described below.

A microfluidic reactor is defined as any reactor which imparts a treatment to a combination of fluid streams such as e.g. temperature treatment, mixing, homogenizing, pressing, gas injection, sonication, microwave treatment. The reactor volume is preferably up to 1000 microliter. Optionally the microfluidic reactor is not a physical reactor but is formed by a mixing node or entry point of further ingredients in line.

Upstream channels are channels that in the normal fluid path indicated by the arrows in FIG. 1, are positioned before the at least two phases Qc and Qd, meet. The upstream channels are positioned before the microfluidic reactors.

Downstream channels are the channels that are positioned after the reactors and hence after two fluid streams have met.

It will be appreciated that several microfluidic reactors may be positions in series and hence the down stream channel for the first reactor, may be the upstream channel relative to the next reactor.

In the microfluidic system according to the invention, the resistance of the upstream channel or channels is higher than the resistance of the down stream channel or channels. It was found that if this requirement is fulfilled, the influence of small variations in flow rate in either of these channels is limited and hence a more robust system is provided.

In a preferred embodiment, the resistance of the upstream channels is preferably at least 10 times, more preferred 100 times larger than the resistance of the down stream channels.

The resistance of the channels may be influenced by a variety of measures. For example decreasing the diameter or increasing the length of the channel may increase the channel resistance. Taking the reverse measures may decrease the resistance.

It will be appreciated that the resistance of the upstream channels can not be made infinitely large because that would lead to practical problems in carrying out the process; e.g. it may lead to the need to put in too much energy to get a reasonable flow through the channels. Therefore for each system there is an upper limit in terms of resistance which may be used. It is within the capabilities of a skilled person to increase the resistance of the upstream channels as much as compatible with a given process and configuration of the system.

The microfluidic system may be used to prepare a variety of products but it is highly suitable for the production of a composition comprising a continuous phase and a dispersed phase. In such embodiment it is preferred that the upstream channel a comprises the continuous phase and upstream channel β comprises the dispersed phase.

The microfluidic system comprises at least two upstream channels feeding into a reactors and at least one downstream channel leading away from the reactors. Optionally a number of such core units are present in the microfluidic system. When used for numbering-up the number of microreactors will generally be from 1000 to 100000 and the number of feeding channels is adapted thereto. For example it could be at least 1000 or even at least 50000.

It is preferred that all microreactors in the system are fed from single source units feeding all upstream channels. Therefore in a preferred embodiment, the upstream channels are divided into a multitude of upstream channels in nodes to feed a multitude of microfluidic reactors.

The best control over the processing conditions in the microreactors is obtained when the flow in all upstream channels is substantially equal and hence such conditions are preferred. Substantially equal flow means that the flow deviates at most 50% in the different upstream channels.

It is preferred that the microfluidic system is used for number-up to create increased volume and throughput. In this embodiment all reactors in the system are preferably identical. However according to another embodiment the system comprises one set of identical reactors and another set of other reactors wherein the product streams resulting from one type of reactors and another type are optionally combined in a later stage of the process.

For particular applications, e.g. the preparation of a variety of customized products, it is preferred that there are several groups of microfluidic systems whereby the reactors differ between the groups.

For high throughput and a single product type preparation, it is preferred that all microfluidic reactors are identical.

The present microfluidic arrangement is particularly advantageous when it is desired to mix two fluids of different viscosity. In particular it is preferred that the fluid sources have a viscosity ratio of at least 5, when measured at 1 s⁻¹ at 25° C.

Such microfluidic elements may be interfaced with the macroscopic world in the following way, which is given here for purpose of completeness but is not a part or limit of the current invention. Each set of reactors is preferably linked to connecting channels, with at least one channel per fluid and per set of reactors. Each connecting channel ends in an output or input channel, with at least one channel per fluid. These inlet and outlet channels connect to the external world. Preferably, the inlet and outlet channels have a resistance much lower than that of the connecting channels. In this way, the inlet and outlet channels act as buffers from which the channels are filled.

Preferably the microfluidic system comprises at least 3 layers. The first layer comprises at least two main inlet channels for fluid supply, and at least 1 outlet channel. This layer is also referred to as inlet/outlet layer. The inlet and outlet channels are preferably arranged parallel. Their internal diameter is preferably from 0.1 micrometer to 500 micrometer more preferred from 10 to 250 micrometer.

The channels may be fabricated using a variety of techniques, such as conventional moulding, drilling and the like. The base material for the first layer is preferably selected from the group comprising stainless steel, glass or polymer such as plastic, or a combination thereof.

The connecting layer is preferably positioned between the inlet/outlet layer and the microfluidic layer. The connecting layer comprises a plurality of side channels with varying diameter and/or length. This difference in diameter/length enables control over the pressure and flow rate conditions experienced by the microfluidic elements connected to the channels of the connecting layer.

The material that is the basis of the connecting layer is preferably selected from the group comprising stainless steel, glass or polymer such as plastic, or a combination thereof.

The third layer is the microfluidic layer, which comprises a plurality of microfluidic reactors. These reactors are connected to the connecting channels via a port and through the connecting channels they are in fluid connection with the main channels that provide the feeding material.

The material of which the microfluidic layer is prepared is preferably selected from the group comprising polymers, glass, steel or silicon, or combinations thereof.

In a preferred embodiment of the invention the microfluidic layers need only be etched on their surface, which may be made using a variety of easily accessible microfabrication techniques, including, but not limited to, wet and dry etching, molding, laser ablation.

Preferably the at least three layers are connected to each other using conventional techniques such as clamping, bolting, bonding e.g. by high temperature treatment, depending on the material that is used.

It is preferred that the connecting layer and the input/output layer are manufactured as a single unit.

Optionally the system is assembled such that the microfluidic layer can easily be removed by a switch lock system enabling variation of the treatment that the inlet fluids undergo in this unit.

The microfluidic system may comprise one of each of the first, second and third layer but alternatively a multitude of one or more of the layers may be present.

In a preferred embodiment, the microfluidic system comprises a plurality of connecting layers connecting a plurality of microfluidic layers to a single first layer.

FIGS. 1 and 2 present alternative schematic embodiments, representative of the invention.

In FIG. 1 a microfluidic network is formed from the following elements. 2 inlets (1) and (3) are used to dispense 2 fluids, which split and flow in the channels (α) and (β), respectively. The two fluids meet at the intersection of channels (α) and (β), before flowing together toward reactors (2), (5) through channels (γ). Such an arrangement could, for example, be used to mix, contact, or otherwise react two liquids. In the following, we will term “upstream channels” all channels or fluid path or other elements which feed the reactors. Likewise, we will term “downstream channels” all channels or fluid path or other elements located after the exact point where the fluid meet, that is channels (γ). We have surprisingly found that increasing the resistance of the upstream channels reduces the sensitivity of the flow rates in the outlets to small differences in the relative resistance of both the downstream or upstream channels. In particular, it strongly reduces the potential of a multiphase shunt within the system.

FIG. 2 presents an alternative schematic embodiment, representative of the invention. A microfluidic network is formed from the following elements. 2 inlets (1) and (2) are used to dispense 2 fluids, which flow in the channels (9) and (10). Each split in two channels (5) and (6), and (7) and (8), respectively. The two fluids meet at the intersection of channels (5) and (8), and (6) and (7) respectively, before flowing together through channels (11) or (12) toward outlets (3) or (4). Such a simple arrangement could, for example, be used to mix, contact, or otherwise react two liquids. In the following, we will term “upstream channels” all channels or fluid path or other elements located before the reactor. Likewise, we will term “downstream channels” all channels or fluid path or other elements located after the exact point where the fluid meet, that is, within channels (11) or (12).

The simple microfluidic network presented in FIG. 1/2 can be generalized in the following way. A more complex microfluidic network involving the parallel action of at least 2 reactors receiving at least 2 different fluids from at least 2 external sources, with exactly one source per fluid, will require the following elements:
(i) inlets and outlets for the fluids
(ii) “splitting node” splitting the fluids coming from the inlets to the various micro-processing elements.
(iii) upstream channels, located between the split and the points where the various fluids meet. These upstream channels are optionally used in the processing, for example for cooling, heating, or otherwise processing the inlet fluids before they join.
(iv) joining nodes, where the fluids from the at least two sources meet and start to interact; these joining nodes may be the reactors.
(v) Downstream channels, located after the joining node, respectively after the reactors, and leading to either the outlets or any collecting channel or gutter which collects the output from the various processing elements. The downstream channels are optionally used to further process the at least two fluids together.

In a further aspect the invention relates to use of the microfluidic system according to invention for the preparation of an oil and water containing composition. Such compositions form the basis for many consumer products in the field of food products and personal care products. The preparation of such compositions using the systems according to the invention enables small scale, fast production of these products. One advantage is that in this way customized products may be more easily prepared. Preparation of customized products in a conventional way is more difficult since this requires a large flexibility and many cleaning operations in a factory whereby the amounts produced are still very large and hence usually only a common selection of a limited type of products is provided. This is overcome by the use of a system according to the invention, which enables small scale, fast manufacturing of a variety of products.

Therefore the invention in particular relates to such use where the oil and water containing composition is selected from the group comprising food products and personal care products.

The food products are preferably selected from the group comprising sauces, dressings, spreadable emulsions, fresh cheese, cream cheese, and mayonnaise.

The personal care products are preferably selected from the group comprising skin cream, shampoo, liquid soap.

The invention also relates to food products or personal care products obtainable by a process wherein the microfluidic system according to the invention is used.

In another aspect the invention relates to a method to increase through put for a microfluidic system comprising at least 2 upstream channels and at least 1 down stream channel, the method comprising increasing the resistance of the upstream channels relative to the resistance of the downstream channels.

1. A microfluidic system comprising first and second fluid supply sources, the first and second supply sources supplying first and second microfluidic reactors via an upstream channel, the first and second reactors each having at least one downstream channel, wherein for at least one reactor, the resistance of each of its upstream channels is higher than the resistance of the downstream channel or channels.

2. A microfluidic system according to claim 1 or 2 wherein, there are at least 1000 microfluidic reactors, each having an upstream channel from the first and second fluid supply streams, and a downstream channel.

3. A microfluidic system according to claim 3, wherein there are at least 50,000 microfluidic reactors, each having an upstream channel from the first and second fluid supply streams, and a downstream channel.

4. A microfluidic system according to any preceding claim, wherein the resistance of the upstream channels is preferably at least 10 times larger than the resistance of the downstream channels.

5. A microfluidic system according to any preceding claim, wherein the resistance of the upstream channels is preferably at least 100 times larger than the resistance of the down stream channels.

6. A microfluidic system according to any preceding claim, wherein the microfluidic reactors are all identical.

7. A microfluidic system, according to any preceding claim, wherein the resistance of the upstream channels of substantially all the reactors is higher than the resistance of the down stream channel or channels.

8. A process for preparing a two phase composition using a microfluidic system according to any preceding claim, wherein for at least one reactor one upstream channel becomes a continuous phase and one upstream channel becomes a dispersed phase in a downstream channel.

9. Process according to claim 8, which is an oil and water containing composition.

10. Process according to claim 9, wherein the oil and water containing composition is selected from the group comprising food products and personal care products.

11. Process according to claim 10, wherein the food products are selected from the group comprising sauces, dressings, spreadable emulsions, fresh cheese, cream cheese and mayonnaise.

12. Process according to claim 10, wherein the personal care products are selected from the group comprising skin cream, shampoo, liquid soap.

13. Process for preparing a composition using a microfluidic system according to any one of claims 1-7, wherein the two fluid sources have a viscosity ratio of at least 5, when measured at 1 s⁻¹ at 25° C.

14. Food product or personal care product obtainable by a process wherein a microfluidic system according to any of claims 1-7 is used.
